(19) United States
(12) Patent Application Publication
(10) Pub. No.: US 2005/0001348 A1
(43) Pub. Date: Jan. 6, 2005

(54) Plastic shaped bodies based on polyvinyl alcohol, method for the production thereof involving thermoplastic methods, and their use

(76) Inventors: Sven Kohnen, Niedernhausen (DE); Martin Steuer, Liederbach (DE); Gerd Lepper, Kelkheim (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/487,702

(22) PCT Filed: Aug. 30, 2002
(86) PCT No.: PCT/EP02/09664

(30) Foreign Application Priority Data
Sep. 1, 2001 (DE) 101 42 922.3

(51) Int. Cl. B29C 47/00; C08J 5/00; C08F 216/06

(52) U.S. Cl. 264/211; 264/331.15; 264/331.17; 264/331.18; 525/56

(57) ABSTRACT

The invention relates to a method for producing polyvinyl alcohol shaped bodies involving thermoplastic processing of at least one polymer (A), of at least one softener and, optionally, of water and/or other additives, whereby polymer (A) contains: a.) 15.0 to 99.9 wt. % structural units of formula (1); b.) 0.0 to 50.0 wt. % structural units of formula (2), and; c.) 0.0 to 50.0 wt. % structural units of formula (3), each with regard to the total weight of polymer (A), whereby radicals R¹, R², R³, R⁴, R⁵, and R⁶ are defined according to the description. The method is characterized in that polymer (A) and the softener are placed into the extruder without being mixed beforehand and that the quantity of water is less than 2 wt. % with regard to polymer (A). The invention also relates to the polyvinyl alcohol shaped bodies, which can be obtained by using the method, and to their use.

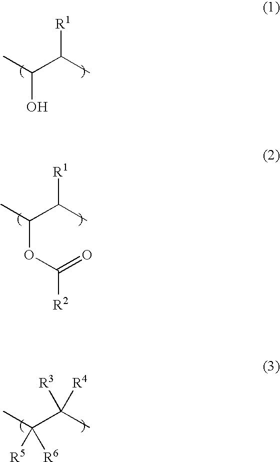

The present invention relates to plastics moldings based on polyvinyl alcohol, to a process for their production by means of thermoplastics processes, and also to their use, in particular as water-soluble packaging materials.

As is known, polyvinyl alcohols are prepared via hydrolysis (alcoholysis) of polyvinyl acetates. This method gives, as hydrolysis proceeds, polymer molecules which are eventually water-soluble, due to the increasing content of OH groups.

The term polyvinyl alcohol hereinafter means polymer molecules whose molecular proportion of vinyl alcohol units is from about 60 to 100 mol %. Each of the remaining monomer units is then a vinyl acetate unit. Although polyvinyl alcohols with a degree of hydrolysis of less than 60 mol % are also known for speciality applications, these are relatively unimportant.

The expression partially hydrolyzed polyvinyl alcohols is generally used when the polyvinyl alcohols have a degree of hydrolysis of from about 80 to 92 mol %, meaning that from 8 to 20 mol % of vinyl acetate units remain in the polymer molecules. In contrast, the polyvinyl alcohols which are termed fully hydrolyzed generally have a degree of hydrolysis of more than 92 mol %. Not only the fully hydrolyzed polyvinyl alcohols but also the partially hydrolyzed polyvinyl alcohols are water-soluble, due to the large number of OH groups.

Vinyl alcohol copolymers are also known, examples being ethylene-vinyl alcohol copolymers.

Due to their water-solubility, polyvinyl alcohols are used, inter alia, in the production of water-soluble moldings, in particular of water-soluble packaging materials.

Other advantages of polyvinyl alcohol moldings are their insolubility in organic solvents, their barrier action with respect to these organic solvents, and also moreover their ability to biodegrade or rot.

In this context, large-scale industrial production of films composed of polyvinyl alcohols first used casting processes from aqueous polyvinyl alcohol solutions, mostly with addition of plasticizing substances.

Not until later did it become possible for these water-soluble packaging materials from polyvinyl alcohol to be produced most-effectively via thermoplastic processing.

The presence of the large number of highly polar OH groups in the molecule here was initially an adverse factor to the extent that intermolecular and intra-molecular hydrogen bonds led to “entangling” of the polymer molecules. The consequence of this was that, although the glass transition temperature (Tg) was in the range from 60 to 80° C., even at temperatures above 200° C. under extrusion conditions it was impossible to achieve sufficient flow of the polyvinyl alcohol to permit thermoplastic processing under industrial conditions in appropriate equipment. Instead, in particular at temperatures above 180° C. and as a result of prolonged residence times at these temperatures, the polyvinyl alcohol underwent a variable degree of decomposition, e.g. with elimination of water, to give yellowish to brownish products. This method could not be used to produce moldings from pure polyvinyl alcohol. The problems described could be eliminated, or at least their incidence dramatically reduced, by adding plasticizers.

DE-A-10 81 229 moreover discloses the preparation of water-soluble, modified polyvinyl alcohols via solvolysis of a graft copolymer of one or more vinyl esters on polyalkylene glycols. However, the use of external plasticizers is again needed for the thermoplastic processing of these materials, as is apparent from EP-A-0 039 854.

The addition of external plasticizers is therefore a general precondition for the thermoplastic processing of polyvinyl alcohols.

These plasticizers are low-molecular-weight organic substances which have relatively high polarity. This polar and hydrophilic structure is needed to achieve maximum compatibility with the polyvinyl alcohol structure, which is likewise highly polar and hydrophilic. Preferred plasticizers are polyhydric alcohols, or else their derivatives, e.g. glycols (e.g. glycol, diglycol, triglycol, and polyethylene glycols), glycerol, diols, and triols. The selection of the plasticizers suitable as constituents of a mixing specification for polyvinyl alcohol compositions intended for thermoplastic processing is known to the person skilled in the art, and has been described in detail in a wide variety of publications.

Polyvinyl alcohol/plasticizer blends are preferably prepared here via mixing of the constituents in a forced-circulation high-speed mixer, using a suitable temperature profile. By way of example, these processes are described in EP-A-0 004 587 and EP-A-0 155 606.

However, the blending procedures necessitate the use of expensive specialized mixing devices and therefore have an adverse effect, in terms both of technology and of cost, on the preparation of the extrusion mixtures, and therefore indirectly on the production of water-soluble moldings, e.g. water-soluble packaging.

Another problem with thermoplastic processing is the plasticizing of the polyvinyl alcohol, because this often gives polyvinyl alcohol pellets whose level of plasticization is not completely uniform and homogeneous. However, because all thermoplastic processing, and in particular blown film extrusion, of appropriate polyvinyl alcohol blends to give water-soluble moldings react with great sensitivity to particles whose level of plastification is not completely homogeneous (fish-eyes), the known processes often give unsatisfactory results. For example, the tiniest fish-eyes can lead to inhomogeneous surfaces of injection moldings, or even to bursting of the extrusion bubble. In every instance, they interfere with the acquired good (cold)-water-solubility of the molding.

In the prior art, the extrusion of polyvinyl alcohol generally takes place via two-stage processes, where a first step mixes polyvinyl alcohol, plasticizer, and, where appropriate, additives in a forced-circulation mixer to give a flowable blend, and the second stage uses an extruder to melt and further process the material to give moldings. Kunstharz-Nachrichten, issue 14, pp. 1-6, 1978, and issue 15, pp. 33-39, 1979 give a summary of a two-stage process of this type. Preparation of the polyvinyl alcohol/plasticizer blend here requires specialized equipment, e.g. forced-circulation mixers, which place stringent requirements upon temperature- and time-related aspects of the mixing process. In addition, to achieve free flow of the blends it is generally necessary to add antiblocking agents, e.g. fine-particle silicas, which can lead to clouding of the moldings produced from the blends.

For example, EP-A-0 415 357 discloses plasticized polyvinyl alcohol pellets which are produced via melt extrusion of a feed composition in which polyvinyl alcohol and a plasticizer are present, the maximum melting point of the pellets being lower than that of the feed composition by at least 5° C. These polyvinyl alcohol pellets are likewise produced via prior forced-circulation mixing of the extruder-feed composition, and the preparation therefore again has the economic disadvantages described above. Furthermore, this process requires cooling of the melt, in order to eliminate, or at least minimize, the thermal decomposition of the melt and resultant formation of fish-eyes. The production of specific moldings moreover also requires a further extrusion process.

EP-A-0 080 664 describes the direct compounding of a polyvinyl alcohol composition with addition of from 5 to 40% by weight of water, based on the polyvinyl alcohol. The amount of water here is selected so that it is firstly sufficient (≧5% by weight) to permit satisfactory extrusion, but is secondly also insufficient to dissolve the polyvinyl alcohol (≦40% by weight). The water used has in turn to be removed in the vent zone of the extruder, thereby entraining certain amounts of the other additives from the mixture (blistering).

Furthermore, the stated barrel temperatures of from 80 to 200° C. and the stated temperatures of from 80 to 130° C. for the polyvinyl alcohol composition at the die can only be used to process low-viscosity partially hydrolyzed polyvinyl alcohols. In particular, the throughputs achieved are also always low, because of the low temperatures of the composition. The process is therefore not only subject to severe restriction in relation to the polyvinyl alcohol types which can be used, but also uneconomic.

The patent application WO93/09171 A describes the thermoplastic processing of biodegradable polymer compositions in which polyvinyl alcohol is present, as is a plasticizer, such as glycerol, ethylene diglycol, and/or propylene diglycol and from 2 to 40% by weight of water, based on the polyvinyl alcohol. Starch is also generally present in the compositions. The thermoplastic processing of these compositions gives moldings with a reduced number of fish-eyes, and it appears that fewer than 100 fish-eyes of dimension smaller than 100 μm are observed per square meter. Nevertheless, users require moldings with an even smaller number of fish-eyes.

Starting from the prior art mentioned, an object of the present invention can be regarded as providing an economic process which does not have the disadvantages known from the prior art for the production of plastics moldings based on polyvinyl alcohol. In particular, this process should permit the production of plastics moldings based on polyvinyl alcohol not only from completely hydrolyzed polyvinyl alcohols but also from partially hydrolyzed polyvinyl alcohols, which may vary within a wide range of viscosity, and also from polyvinyl alcohol copolymers.

Another object of the present invention was to provide a process which permits the production of plastics moldings based on polyvinyl alcohol with a minimum number of fish-eyes of minimum size.

Surprisingly, it has been found that plastics moldings based on polyvinyl alcohol can be produced via extrusion of vinyl alcohol polymers and/or of vinyl alcohol copolymers, of at least one plasticizer, and also, where appropriate, of water, and of additives, without any prior mixing of vinyl alcohol (co)polymer and plasticizer.

Surprisingly, this method also gives moldings with an extremely low fish-eye content. Typically, the moldings obtained have fewer than 100 fish-eyes per square meter, all of the fish-eyes being of dimension less than 1 mm.

The present invention therefore provides a process for producing plastics moldings via thermoplastic processing of at least one polymer (A), of at least one plasticizer, and also, where appropriate, of water and/or of other additives, which is characterized in that the polymer (A) and the plasticizer are introduced with no prior mixing into the extruder, and that the proportion of water, this being the total of the proportions of water in the starting components, is less than 2% by weight, based on the polyvinyl alcohol.

According to the present invention, the polymer (A) comprises, based in each case on its total weight
a.) from 15.0 to 99.9% by weight, preferably from 25.0 to 99.9% by weight, advantageously from 40.0 to 99.9% by weight, in particular from 50.0 to 99.9% by weight, of structural units of the formula (1) 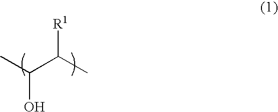
b.) from 0.0 to 50.0% by weight, preferably from 0.1 to 50.0% by weight, of structural units of the formula (2) 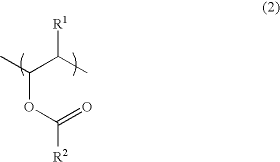
c.) from 0.0 to 50.0% by weight of structural units of the formula (3)

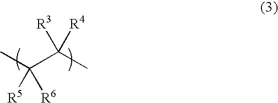

The respective structural units here are naturally different from one another, and in particular the structural unit of the general formula (3) does not encompass the structural units of the general formula (1) and/or (2).

Each radical R¹, independently of the others, is hydrogen or methyl, preferably hydrogen.

The radical R² indicates an alkyl radical having from 1 to 6 carbon atoms, advantageously a methyl, ethyl, n-propyl, isopropyl, n-butyl, sec-butyl, tert-butyl, n-pentyl, or n-hexyl group, very advantageously a methyl or ethyl group, in particular a methyl group.

Each of the radicals R³, R⁴, R⁵, and R⁶, independently of the others, is a radical having a molar mass in the range from 1 to 500 g/mol, advantageously hydrogen, or a radical having from 1 to 16 carbon atoms which is, where appropriate, branched, and is aliphatic or cycloaliphatic, and which may, where appropriate, contain one or more carboxylic acid, carboxylic anhydride, carboxylic ester, carboxamide, and/or sulfonic acid groups.

Particularly preferred structural units of the formula (3) derive from straight-chain or branched olefins having 2 to 18 carbon atoms, from (meth)acrylic acid, from maleic acid, from maleic anhydride, from fumaric acid, from itaconic acid, from (meth)acrylamides, and/or from ethylenesulfonic acid. Olefins have proven very particularly advantageous here, in particular those having a terminal carbon-carbon double bond and preferably having from 2 to 6 carbon atoms, in particular ethylene. According to the invention, furthermore, structural units (3) which derive from acrylamidopropenylsulfonic acid (AMPS) also give very particularly advantageous results.

The total number of structural units of the formula (2) is preferably in the range from 0.1 to 50 mol %, advantageously in the range from 0.1 to 30 mol %, very advantageously in the range from 0.1 to 20 mol %, in particular in the range from 0.1 to 16 mol %, based in each case on the total number of structural units of the formula (1) and (2). Particularly advantageous results are found for the purposes of the present invention when the total number of structural units of the formula (2) is in the range from 0.3 to 13 mol %, in particular in the range from 0.5 to 10 mol %, based in each case on the total number of structural units of the formula (1) and (2).

The total number of structural units of the formula (3) is preferably in the range from 0.1 to 20 mol %, advantageously in the range from 2 to 19 mol %, in particular in the range from 2.5 to 17 mol %, based in each case on the total number of structural units of the formula (1), (2), and (3). Particularly advantageous results are achievable for the purposes of the present invention if the total number of structural units of the formula (3) is in the range from 3.0 to 15 mol %, in particular in the range from 3.5 to 13 mol %, based in each case on the total number of structural units of the formula (1), (2), and (3).

For the purposes of one particularly preferred embodiment of the present invention, the polymer (A) used comprises an ethylene-vinyl alcohol copolymer having from 1 to 19 mol %, preferably from 2 to 10 mol %, of units (3) which derive from ethylene, and from 75 to 99 mol %, preferably from 90 to 98 mol %, of units (1), where R¹ is hydrogen, based in each case on the content of units (1), (2), and (3). By way of example, copolymers of this type are commercially available with the tradename Exceval®.

According to the invention, the polymer (A) contains, based in each case on its total weight, preferably >60% by weight, advantageously >70% by weight, in particular >80% by weight, of structural units of the formula (1) and/or (2). Particularly advantageous results may be achieved here with polymers (A) which, based in each case on their total weight, contain >85% by weight, advantageously >90% by weight, very advantageously >95% by weight, in particular >99% by weight, of structural units of the formula (1) and/or (2).

For the purposes of the present invention, the polymer (A) may have a syndiotactic, isotactic, and/or atactic chain structure. Furthermore, it may, where appropriate, be either a random copolymer or else a block copolymer.

These polymers (A) may be prepared in a manner known per se in a two-stage process. The corresponding vinyl ester is polymerized by a free-radical route in a first step in a suitable solvent, generally water or an alcohol, such as methanol, ethanol, propanol, and/or butanol, using a suitable free-radical initiator. If the polymerization is carried out in the presence of monomers capable of free-radical copolymerization, the corresponding vinyl ester copolymers are obtained.

The vinyl ester (co)polymer is then hydrolyzed in a second step, usually via transesterification with methanol, and the degree of hydrolysis can be adjusted here as desired in a manner known per se, for example via variation of the catalyst concentration, of the reaction temperature, and/or of the reaction time. For further details, reference is made to the familiar technical literature, in particular to Ullmann's Encyclopedia of Industrial Chemistry, Fifth Edition on CD-ROM Wiley-VCH, 1997, Keyword: Poly(Vinyl Acetals), and the references cited therein.

The European patent application EP-1,008,605 A describes the preparation of copolymers which are particularly suitable according to the invention, and the disclosure thereof is hereby expressly incorporated herein by way of reference.

All of the known polyvinyl alcohols can be processed thermoplastically by the process of the invention. This means that not only low-viscosity, partially hydrolyzed polyvinyl alcohols but also high-viscosity, fully hydrolyzed polyvinyl alcohols can be processed thermoplastically. Mixtures of various polyvinyl alcohols can also be processed thermoplastically.

However, the present invention is not restricted to the use of “conventional” polyvinyl alcohols. Rather, the use of graft polymers has also proven particularly advantageous. These are advantageously obtained by grafting the vinyl ester(s) in a known manner onto at least one polyalkylene glycol, preferably polyethylene glycol or polypropylene glycol, in particular polyethylene glycol, and then hydrolyzing some or all of the ester groups, preferably in methanol. This polyalkylene glycol preferably has a weight-average molar mass in the range from 100 to 10 000 000 g/mol, advantageously in the range from 200 to 1 000 000 g/mol, very advantageously in the range from 200 to 200 000 g/mol, in particular in the range from 500 to 25 000 g/mol. According to the invention, particularly advantageous results may be achieved if the polyalkylene glycol has a weight-average molar mass in the range from 500 to 10 000 g/mol. This weight average is determined in a manner known per se, preferably via static light scattering.

Particularly advantageous graft polymers contain from 1 to 50% by weight, preferably from 10 to 50% by weight, of alkylene oxide units, and from 50 to 99% by weight, preferably from 50 to 90% by weight, of units (2) and/or (3).

Valuable information concerning the preparation of graft polymers which are particularly suitable according to the invention may be found in the publications de 1 081 229 A and DE 1 094 457 A, the disclosure of which is hereby expressly incorporated herein by way of reference.

According to the invention, the viscosity of the polymer (A) is of subordinate importance, and in principle it is possible to utilize either low-molecular-weight or high-molecular-weight polymers (A). However, for the purposes of the present invention it has proven very particularly advantageous for the polymer (A) to have a viscosity in the range from 2 to 70 mPas, preferably in the range from 2 to 40 mPas, very advantageously in the range from 3 to 30 mPas, in particular in the range from 3 to 15 mPas (measured as a 4% strength by weight aqueous solution, Höppler method at 20° C., DIN 53015).

In one particularly preferred embodiment of the present invention, the thermoplastically processible polymer (A) has internal plasticization, i.e. it contains suitable comonomer units (3) which lower the melting point of the polymer (A) when comparison is made with the melting point of the polymer (measured by means of DSC) without these units. Comonomer units particularly suitable in this connection have one or more ethylene glycol units (—O—CH₂—CH₂—O—) and/or propylene glycol units (—O—CH(CH₃)—CH₂—O—).

Plasticizers which may be used comprise any of the plasticizers known to the person skilled in the art and compatible with polyvinyl alcohol, and also mixtures of the same. Preferred plasticizers are alcohols, preferably polyhydric alcohols, and their derivatives, such as, for example, glycols (e.g. glycol, diglycol, triglycol, and polyethylene glycols), glycerol, diols, and triols. Externally plasticized polymers (A) which are very particularly preferred according to the invention are described in the publications EP 0,004,587 A and EP 0,155,606 A, the disclosure of which is hereby expressly incorporated herein by way of reference. The amount preferably used of the materials is from 0.1 to 20 parts by weight per 100 parts by weight of polymer (A).

Furthermore, a small proportion of water may also be added during the process of the invention. However, the low proportion of water, in the range from 0 to <2.0% by weight, based on the polymer (A) used, is an advantage of the process of the invention. There is therefore no need for any costly and inconvenient removal of relatively large amounts of water in the vent zone of the extruder.

For the purposes of the present invention, the stated amounts of water encompass not only the proportions of water in the starting components but also, where appropriate, separately added water. In one particularly advantageous embodiment of the present invention, the amount of water added is less than 1.5% by weight, preferably less than 1.0% by weight, very advantageously less than 0.5% by weight, in particular less than 0.1% by weight, based in each case on the total weight of the polymer (A).

In another particularly preferred embodiment of the present invention, the amount of water added is at least 0.1% by weight, preferably 0.5% by weight, in particular 1.0% by weight, based in each case on the total weight of polymer (A).

Methods for determining the water content are very well known to the person skilled in the art. For the purposes of the present invention, the Karl Fischer method of water determination using a drying oven has proven particularly successful, this method being specified in more detail in the DIN 51777 standard.

Use may also be made of the following, preferably solid, additives: lubricants, antiblocking agents, antioxidants, pigments, dyes, solid plasticizers, fillers, and/or other polymeric compounds.

According to the invention, use may be made of any of the processes known to the person skilled in the art for thermoplastic processing. Correspondingly, use may also be made of any of the equipment known to the person skilled in the art and suitable for this purpose. However, preference is given to melt extrusion and therefore to the use of melt extruders. Self-cleaning twin-screw extruders are particularly preferably used.

The selection of suitable extruder screws, the geometries of which have to be matched to the expected processing functions, e.g. intake, conveying, homogenizing, melting, and compressing, is within the general knowledge of the person skilled in the art.

The individual constituents (polymer (A), plasticizer, water and other additives) may be introduced here in any desired spatial sequence. However, the solid polymer (A) is preferably introduced within the feed zone of the extruder, where appropriate together with other constituents. For instance, the polymer (A) may be added within the feed zone of the extruder, for example together with the plasticizer and, where appropriate, with the water. However, it is preferable that the addition of the plasticizer and, where appropriate, the addition of the water take place in one of the zones of the extruder which are downstream of the feed zone. However, it is particularly preferable that the addition of the plasticizer and of the water, if used, is spatially separate from that of the polymer (A), in order to avoid caking in the intake section.

Other liquid additives may be added together with the plasticizer, or by way of one or more other separate liquid-feed systems. Solid additives may be added either after solution or suspension in the plasticizer or by way of other solid-feed equipment, preferably located either in the feed zone or in one of the zones downstream of the feed zone. A laterally attached screw feed is particularly preferred for the addition of solid additives.

Barrel temperatures set in the intake section of the screw extruder are preferably in the range from 20 to 60° C. Downstream of the intake section, there are zones in which the material is melted and homogenized, and downstream of these there is the metering section (dies). It is preferable here to use kneading blocks to homogenize the melt. The temperature profiles set in the melting and homogenizing section are preferably in the range from 130 to 250° C., particularly preferably from 150 to 230° C. Temperatures in the range from 170 to 230° C. are preferably set in the metering section. In the practice of the process of the invention, it is particularly preferable to use a rising temperature profile from the feed zone to the die when setting the heating zones of the extruder. The temperature profile used here varies as a function of the polymer (A) used. For instance, in the case of low-viscosity partially hydrolyzed polymers (A) operations may be carried out at markedly lower temperatures than those for high-viscosity fully hydrolyzed polymers (A). The maximum barrel temperatures in the homogenizing section of the extruder are therefore from 190 to 210° C. for partially hydrolyzed polyvinyl alcohols and from 200 to 250° C. for fully hydrolyzed polyvinyl alcohols.

Volatile fractions may moreover be removed from the melt by venting at atmospheric pressure or by applying suction, after melting and homogenization. This venting preferably takes place directly upstream of the extruder tool. If a melt pump is used to give a uniform conveying rate, the venting takes place immediately upstream of the melt pump.

In the melt extrusion process of the invention, no cooling of the melt is needed. Instead, it has surprisingly been found that additional heat can indeed be introduced by way of the heating zones of the extruder without any significant resultant thermal degradation of the vinyl alcohol (co)polymer composition or of the moldings produced therefrom. It is also surprising that particularly homogeneous moldings are obtained when additional heat is supplied to the melt within the barrel and within the die of the extruder. In addition, the additional introduction of heat and the resultant high temperatures obtainable for the composition lead to a lowering of the viscosity of the melt, which permits higher throughputs in the process of the invention when comparison is made with the processes known from the prior art.

It is possible to produce moldings directly by the process of the invention via the use of appropriate dies, e.g. flat dies, annular dies, or profile dies. This method can produce moldings such as flat films, blown films, pellets, fibers, or monofilaments. The moldings are cooled after leaving the extruder die by processes known to the person skilled in the art. Preference is given to the production of pellets. These are pelletized by processes known to the person skilled in the art after leaving the extruder die and after cooling. The pellets produced may be further processed in downstream assemblies to give injection moldings, various thicknesses of blown or flat films, or else fibers or monofilaments.

The moldings produced by the process of the invention have excellent clarity and transparency, high homogeneity, low fish-eye content, and are substantially colorless, with defined solubility adjustable by way of the formulation.

The present invention therefore also provides the moldings obtainable by way of the process of the invention.

Depending on the vinyl alcohol (co)polymer composition used, the moldings of the invention feature different water solubilities, and are substantially free from unmelted constituents (fish-eyes). Depending on the vinyl alcohol (co)polymer composition used, and, where appropriate, on additives used, different solubilities can be set with respect to acidic, alkaline, or detersive media.

Surprisingly, it has also been found that moldings produced by way of the process of the invention have a maximum melting point, measured by DSC, which is higher than that of an identical blend composition prepared by means of a forced-circulation mixer.

By way of example, the moldings of the invention may be used for the packaging of solid and liquid products. One particular property of these moldings of the invention is the water-solubility which can be adjusted as desired under a very wide variety of conditions of use.

The present invention therefore also provides the use of the moldings of the invention as packaging materials.

The invention is described in more detail below using examples, but is not restricted to these.

DSC Measurements

The DSC measurements are made using a robot-assisted DSC820 device from Mettler. The measurements are made at from −10° C. to 250° C., using a heating rate of 20° C./min. The material is heated and cooled, in each case at 20° C./min, giving a total of 3 measurement curves (1st heating, 1st cooling, and 2nd heating). The amount weighed out of the specimens is in each case about 10 mg.

### EXAMPLES 1 TO 16 (COMPARISON)

Production of the Polyvinyl Alcohol Pellets

The formulations given in Table 1 are extruded on a ZSE 27 GL 1200 Leistritz twin-screw extruder with screw diameter 27 mm, an L/D of 40, and 9 heating zones. The temperature settings for the individual heating zones are given in Table 2. Vacuum venting is used at 37 D. A perforated die is used to produce strands. The resultant strands are homogeneous and free from blisters. The cooling methods used are a mesh belt with air cooling and also water-bath cooling, with downstream pelletization.

The pellets produced in Example 2 are analyzed by means of DSC measurement in comparison with a blend prepared using a forced-circulation mixer (blend preparation as in Kunstharz-Nachrichten, issue 14, pp. 1-6, 1978). The maximum melting point for the blend prepared in the mixer is 168° C., while the pellets produced by means of direct compounding as in Example 2 have a maximum melting point of 169° C. In each case the second heating procedure is the basis for evaluation.

### EXAMPLE 17 (COMPARISON)

The pellets produced in Example 1 are processed in a RICO injection-molding machine with 1000 kN locking force, 36 mm screw diameter, open nozzle, max. shot volume 152 ml, using a spiral mold, to give a homogeneous spiral measuring 2 mm in thickness, 8 mm in width, and 44 cm in length.

Setting of heating zones:

Zone 1: 160° C.

Zones 2-4: 170° C.

The spiral is assessed visually as free from unmelted fractions.

In comparison with this, a blend prepared using a forced-circulation mixer and having the same formulation as in Example 1 (blend preparation as in Kunstharz-Nachrichten, issue 14, pp. 1-6, 1978) is processed under analogous conditions, whereupon a spiral of length 40 cm is obtained with low contents of inhomogeneously melted material.

### EXAMPLES 18 TO 25 (COMPARISON)

The pellets produced in Examples 2, 3, 7, 10, 11, 12, 14, and 16 are processed analogously to Example 17 in comparison with blends of the same formulation prepared using a forced-circulation mixer (blend preparation as in Kunstharz-Nachrichten, issue 14, pp. 1-6, 1978) in an injection-molding machine, likewise to give spirals of various length.

The temperature profile of the heating zones is raised by from 10 to 40° C. for formulations with fully hydrolyzed polyvinyl alcohols, and also for formulations with relatively high-viscosity partially hydrolyzed formulations.

When using the pellets of the invention, the spirals are in every case longer and comprise lower amounts of inhomogenously melted fractions than when using blends of the prior art.

TABLE 1
Formulations for producing the polyvinyl alcohol
pellets of Examples 1 to 16 (all data in parts by
weight)

| Example | 1 | 2 | 3 | 4 | 5 | 6 |
|---|---|---|---|---|---|---|
| Type of | 4-88 | 8-88 | 18-88 | 26-88 | 30-92 | 40-88 |
| PVOH* | | | | | | |
| Type of PVOH¹ | 1000 | 1000 | 1000 | 1000 | 1000 | 1000 |
| ® Mowilith | 20 | | | 25 | 25 | |
| DM 117P² | | | | | | |
| ® Mowilith | | 35 | | | | 60 |
| DH 257³ | | | | | | |
| ® Mowilith | | | 42 | | | |
| LD 167³ | | | | | | |
| Stearic acid² | 2 | 2.5 | 2 | 2.5 | 2.5 | 2.5 |
| Glycerol³ | | 120 | | 50 | 175 | 200 |
| PEG 200³ | 80 | | 110 | | | |
| PEG 400³ | | | | | | |
| Trimethylol | | | | 100 | | |
| propane^{2/3} | | | | | | |
| Water³ | 30 | 45 | 33 | 45 | 45 | 30 |
| ® Hostanox O3² | 3.5 | 3.5 | 3.5 | 4 | 4 | 4 |
| Rotation | 400 | 400 | 200 | 400 | 300 | 200 |
| rate [rpm] | | | | | | |
| Throughput | 22 | 19 | 9 | 21 | 16 | 12 |
| [kg/h] | | | | | | |
| Kneading | 2, 4, 7 | 2, 4, 6, 7 | 1, 3, 5, 7, 8 | 1, 3, 5, 7, 8 | 1, 3, 5, 7, 8 | 1, 3, 5, 7, 8 |
| blocks at | | | | | | |
| zone | | | | | | |

| Example | 7 | 8 | 9 | 10 | 11 | 12 |
|---|---|---|---|---|---|---|
| Type of | 4-98 | 15-96 | 28-99 | 4-88/ | 8-88/ | 30-92/ |
| PVOH* | | | | 8-88 | 18-88 | 10-98 |
| Type of | 1000 | 1000 | 1000 | 500/500 | 750/250 | 750/250 |
| PVOH¹ | | | | | | |
| ® Mowilith | 25 | 25 | | 23 | 35 | 25 |
| DM 117P² | | | | | | |
| ® Mowilith | | | | | | |
| DH 257³ | | | | | | |
| ® Mowilith | | | 50 | | | |
| LD 167³ | | | | | | |
| Stearic | 2 | 2.5 | 2.5 | 2 | 3 | 2.5 |
| acid² | | | | | | |
| Glycerol³ | | 175 | 180 | | 120 | 180 |
| PEG 200³ | | | | 90 | | |
| PEG 400³ | | | | | | |
| Trimethylol | 120 | | | | | |
| propane^{2/3} | | | | | | |
| Water³ | 45 | 45 | 30 | 35 | 45 | 45 |
| ® Hostanox | 4 | 4 | 4 | 3.5 | 3.5 | 4 |
| O3² | | | | | | |
| Rotation | 400 | 350 | 400 | 400 | 300 | 300 |
| rate [rpm] | | | | | | |
| Throughput | 20 | 15 | 18 | 20 | 16 | 18 |
| [kg/h] | | | | | | |
| Kneading | 1, 3, 5, 7, 8 | 1, 3, 5, 7, 8 | 1, 3, 5, 7, 8 | 2, 4, 6, 7 | 1, 3, 5, 7, 8 | 1, 3, 5, 7, 8 |
| blocks at | | | | | | |
| zone | | | | | | |

| Example | 13 | 14 | 15 | 16 |
|---|---|---|---|---|
| Type of PVOH* | 4-98/ | 28-99/ | 8-88 | 28-99 |
| | 15-96 | 56-98 | | |
| Type of PVOH¹ | 250/750 | 600/400 | 1000 | 1000 |
| ® Mowilith DM 117P² | 25 | | | |
| ® Mowilith DH 257³ | | | | |
| ® Mowilith LD 167³ | | 50 | | |
| Stearic acid² | 2 | 2.5 | | |
| Glycerol³ | | 230 | 50 | 180 |
| PEG 200³ | | | | |
| PEG 400³ | | | | |
| Trimethylolpropane^{2/3} | 150 | | | |
| Water³ | 45 | 40 | 30 | 45 |
| ® Hostanox O3² | 4 | 4 | 4 | 4 |
| Rotation rate [rpm] | 400 | 300 | 400 | 400 |
| Throughput [kg/h] | 19 | 12 | 21 | 19 |
| Kneading blocks at | 1, 3, 5, 7, 8 | 1, 3, 5, 7, 8 | 2, 4, 6, 7 | 1, 3, 5, 7, 8 |
| zone | | | | |

*The first number in each case gives the viscosity of a 4% strength by weight aqueous solution at 20° C. in mPas, and the second number in each case gives the degree of hydrolysis in mol %.
¹Feed by way of feed zone at 2 D
²Lateral feed at 12 D
³Liquid feed at 8 D

TABLE 2
Temperature settings for the individual heating zones
of the Leistritz twin-screw extruder (all data in ° C.)

| Example | 1 | 2 | 3 | 4 | 5 | 6 | 7 | 8 |
|---|---|---|---|---|---|---|---|---|
| Zone 1 | 30 | 30 | 30 | 30 | 30 | 30 | 30 | 30 |
| Zone 2 | 50 | 50 | 50 | 60 | 60 | 60 | 50 | 50 |
| Zone 3 | 90 | 90 | 90 | 100 | 100 | 100 | 90 | 100 |
| Zone 4 | 130 | 140 | 140 | 150 | 150 | 160 | 130 | 150 |
| Zone 5 | 170 | 180 | 190 | 200 | 200 | 200 | 170 | 190 |
| Zone 6 | 180 | 190 | 200 | 210 | 210 | 220 | 190 | 210 |
| Zone 7 | 180 | 190 | 200 | 210 | 210 | 220 | 190 | 210 |
| Zone 8 | 180 | 190 | 200 | 210 | 210 | 220 | 190 | 210 |
| Zone 9 | 180 | 190 | 200 | 210 | 210 | 220 | 180 | 210 |
| Die | 180 | 190 | 200 | 210 | 210 | 220 | 180 | 210 |
| Temperature of | 181 | 189 | 201 | 212 | 213 | 222 | 179 | 209 |
| composition | | | | | | | | |
| Example | 9 | 10 | 11 | 12 | 13 | 14 | 15 | 16 |
| Zone 1 | 30 | 30 | 30 | 30 | 30 | 30 | 30 | 30 |
| Zone 2 | 50 | 50 | 50 | 60 | 50 | 50 | 50 | 50 |
| Zone 3 | 100 | 90 | 90 | 100 | 90 | 100 | 90 | 100 |
| Zone 4 | 150 | 140 | 140 | 150 | 140 | 150 | 140 | 150 |
| Zone 5 | 190 | 180 | 185 | 200 | 190 | 200 | 180 | 190 |
| Zone 6 | 215 | 190 | 195 | 210 | 205 | 220 | 190 | 215 |
| Zone 7 | 220 | 190 | 200 | 210 | 210 | 240 | 190 | 220 |
| Zone 8 | 220 | 190 | 200 | 210 | 210 | 240 | 190 | 220 |
| Zone 9 | 220 | 190 | 190 | 210 | 205 | 240 | 190 | 220 |
| Die | 220 | 190 | 190 | 210 | 205 | 235 | 190 | 220 |
| Temperature of | 219 | 188 | 192 | 209 | 208 | 236 | 190 | 218 |
| composition | | | | | | | | |

### EXAMPLE 26 (COMPARISON)

The pellets produced in Example 2 are extruded on a Göttfert blown-film extruder, single 30 mm screw, L/D=25, die diameter 30 mm, die width 0.6 mm, using a screw with constantly increasing root diameter at a rotation rate of 50 rpm and a throughput of 3.5 kg/h, to give blown films of thickness about 20 μm, in comparison 15 with a blend of the same formulation (blend preparation as in Kunstharz-Nachrichten, issue 14, pp. 1-6, 1978) prepared using a forced-circulation mixer.

Screw compression ratio: 1:4

Setting of heating zones:

Zones 1 and 2: 205° C.

Zone 3: 200° C.

Zones 4-6: 195° C.

Die: 170° C.

The films obtained are analyzed for fish-eyes using a film quality analyzer (FQA) from Brabender, composed of a CCD linear-array camera with illumination unit and with separate EDP-assisted evaluation system. The film produced from the pellets as in Example 2 has a fish-eye frequency (fish-eyes >400 μm) which is lower by a factor of 10 than that of the film produced from the blend of the prior art.

### EXAMPLES 27-33 (COMPARISON)

The pellets produced in Examples 4, 5, 6, 8, 9, 13, and 15 are extruded on a Gottfert blown-film extruder to give blown films, analogously with Example 26 in comparison with a blend of the same formulation (blend preparation as in Kunstharz-Nachrichten, issue 14, pp. 1-6, 1978) prepared using a forced-circulation mixer, and analyzed for fish-eyes.

In the case of formulations using fully hydrolyzed polyvinyl alcohols, use is made here of a screw whose compression ratio is 1:2.5. The temperature profile of the heating zones is raised by from 10 to 20° C. for formulations using fully hydrolyzed polyvinyl alcohols, and also for formulations using relatively high-viscosity, partially hydrolyzed formulations.

In every case, the resultant fish-eye content for films made from the pellets as in Examples 4, 5, 6, 8, 9, 13, and 15 is lower than for films produced as in the prior art.

### EXAMPLES 34-40 (COMPARISON)

Production of the polyvinyl alcohol pellets

The formulations given in Table 3 are extruded on a ZSE 27 GL 1200 Leistritz twin-screw extruder with screw diameter 27 mm, an L/D of 40, and 9 heating zones. The temperature settings for the individual heating zones are given in Table 4. Vacuum venting is used at 37 D. A perforated die is used to produce strands. The resultant strands are homogeneous and free from blisters. The cooling methods used are a mesh belt with air cooling and also water-bath cooling, with downstream pelletization.

The fish-eye frequency evaluation is found in Table 5.

TABLE 3
Formulations for the production of the polyvinyl
alcohol pellets of Examples 34-40 (all data in parts by
weight) on Leistritz twin-screw extruder of Example 1

| Example | 34 | 35 | 36 | 37 | 38 | 39 | 40 |
|---|---|---|---|---|---|---|---|
| Type of PVOH* | 8-88 | 18-88 | 26-88 | 30-92 | 15-96 | 28-99 | 28-99/ |
| | | | | | | | 56-98 |
| Type of PVOH¹ | 1000 | 1000 | 1000 | 1000 | 1000 | 1000 | 600/400 |
| ® Mowilith DM 117P² | 35 | 25 | 25 | 35 | 25 | 25 | 25 |
| Stearic acid² | 2.5 | 2 | 2.5 | 2.5 | 2.5 | 2.5 | 2.5 |
| Glycerol³ | 120 | | 50 | 175 | 180 | 180 | 230 |
| PEG 200³ | | 120 | | | | | |
| Trimethylolpropane^{2/3} | | | 100 | | | | |
| Water³ | 45 | 33 | 40 | 40 | 45 | 30 | 40 |
| Rotation rate [rpm] | 400 | 200 | 400 | 300 | 350 | 400 | 300 |
| Throughput [kg/h] | 18 | 11 | 19 | 16 | 15 | 19 | 13 |
| Kneading blocks | 2, 4, | 1, 3, | 1, 3, | 1, 3, | 1, 3, | 1, 3, | 1, 3, |
| at zone | 6, 7 | 5, 7, 8 | 5, 7, 8 | 5, 7, 8 | 5, 7, 8 | 5, 7, 8 | 5, 7, 8 |

*The first number in each case gives the viscosity of a 4% strength by weight aqueous solution at 20° C. in mPas, and the second number in each case gives the degree of hydrolysis in mol %.
¹Feed by way of feed zone at 2 D
²Lateral feed at 12 D
³Liquid feed at 8 D

TABLE 4
Temperature settings for the individual heating zones
of the Leistritz twin-screw extruder (all data in ° C.)

| Example | 34 | 35 | 36 | 37 | 38 | 39 | 40 |
|---|---|---|---|---|---|---|---|
| Zone 1 | 30 | 30 | 30 | 30 | 30 | 30 | 30 |
| Zone 2 | 50 | 50 | 60 | 60 | 50 | 50 | 50 |
| Zone 3 | 90 | 90 | 100 | 100 | 100 | 100 | 100 |
| Zone 4 | 140 | 140 | 150 | 150 | 150 | 150 | 150 |
| Zone 5 | 180 | 190 | 200 | 200 | 190 | 190 | 200 |
| Zone 6 | 190 | 200 | 210 | 210 | 210 | 215 | 220 |
| Zone 7 | 190 | 200 | 210 | 210 | 210 | 220 | 240 |
| Zone 8 | 190 | 200 | 210 | 210 | 210 | 220 | 240 |
| Zone 9 | 190 | 200 | 210 | 210 | 210 | 220 | 240 |
| Die | 190 | 200 | 210 | 210 | 210 | 220 | 235 |
| Temperature of | 190 | 200 | 209 | 209 | 210 | 221 | 236 |
| composition | | | | | | | |

TABLE 5
Results from Brabender film quality analyzer
Number of fish-eyes in various size classes

| Example | 34 | 35 | 36 | 37 | 38 | 39 | 40 |
|---|---|---|---|---|---|---|---|
| 40-100 μm | 88 | 75 | 78 | 95 | 90 | 110 | 120 |
| 100-300 μm | 30 | 35 | 29 | 15 | 24 | 45 | 60 |
| 300-800 μm | 8 | 10 | 11 | 6 | 12 | 20 | 38 |
| >800 μm | 1 | 0 | 2 | 0 | 1 | 5 | 8 |

### EXAMPLES 41-47 (INVENTIVE EXAMPLES)

Production of the Polyvinyl Alcohol Pellets

The formulations given in Table 6 are extruded on a ZSE 27 GL 1200 Leistritz twin-screw extruder with screw diameter 27 mm, an L/D of 40, and 9 heating zones. The temperature settings for the individual heating zones are given in Table 7. Vacuum venting is used at 37 D. A perforated die is used to produce strands. The resultant strands are homogeneous and free from blisters. The cooling methods used are a mesh belt with air cooling and also water-bath cooling, with downstream pelletization.

The fish-eye frequency evaluation is found in Table 8.

TABLE 6
Formulations for the production of the polyvinyl
alcohol pellets of Examples 41-47 (all data in parts by
weight) on Leistritz twin-screw extruder of Example 1.

| Example | 41 | 42 | 43 | 44 | 45 | 46 | 47 |
|---|---|---|---|---|---|---|---|
| Type of PVOH* | 8-88 | 18-88 | 26-88 | 30-92 | 15-96 | 28-99 | 28-99/ |
| | | | | | | | 56-98 |
| Type of PVOH¹ | 1000 | 1000 | 1000 | 1000 | 1000 | 1000 | 600/400 |
| ® Mowilith DM 117P² | 35 | 25 | 25 | 35 | 25 | 25 | 25 |
| Stearic acid² | 2.5 | 2 | 2.5 | 2.5 | 2.5 | 2.5 | 2.5 |
| Glycerol³ | 120 | | 50 | 175 | 180 | 180 | 230 |
| PEG 200³ | | 120 | | | | | |
| Trimethylolpropane² | | | 100 | | | | |
| Rotation rate [rpm] | 400 | 200 | 400 | 300 | 350 | 400 | 300 |
| Throughput [kg/h] | 17 | 11 | 20 | 15 | 14 | 19 | 14 |
| Kneading blocks | 2, 4, | 1, 3, | 1, 3, | 1, 3, | 1, 3, | 1, 3, | 1, 3, |
| at zone | 6, 7 | 5, 7, 8 | 5, 7, 8 | 5, 7, 8 | 5, 7, 8 | 5, 7, 8 | 5, 7, 8 |

*The first number in each case gives the viscosity of a 4% strength by weight aqueous solution at 20° C. in mPas, and the second number in each case gives the degree of hydrolysis in mol %.
¹Feed by way of feed zone at 2 D
²Lateral feed at 12 D
³Liquid feed at 8 D

TABLE 7
Temperature settings for the individual heating zones
of the Leistritz twin-screw extruder (all data in ° C.)

| Example | 41 | 42 | 43 | 44 | 45 | 46 | 47 |
|---|---|---|---|---|---|---|---|
| Zone 1 | 40 | 40 | 40 | 40 | 40 | 40 | 40 |
| Zone 2 | 70 | 70 | 70 | 70 | 70 | 70 | 70 |
| Zone 3 | 100 | 100 | 110 | 110 | 110 | 110 | 120 |
| Zone 4 | 150 | 150 | 160 | 160 | 160 | 160 | 180 |
| Zone 5 | 190 | 190 | 205 | 205 | 195 | 200 | 215 |
| Zone 6 | 200 | 210 | 215 | 215 | 210 | 215 | 225 |
| Zone 7 | 200 | 210 | 215 | 215 | 210 | 220 | 240 |
| Zone 8 | 200 | 200 | 215 | 215 | 215 | 225 | 240 |
| Zone 9 | 190 | 200 | 210 | 210 | 215 | 225 | 240 |
| Die | 190 | 200 | 210 | 210 | 210 | 220 | 235 |
| Temperature of | 192 | 203 | 211 | 212 | 213 | 223 | 238 |
| composition | | | | | | | |

TABLE 8
Results from Brabender film quality analyzer
Number of fish-eyes in various size classes

| Example | 41 | 42 | 43 | 44 | 45 | 46 | 47 |
|---|---|---|---|---|---|---|---|
| 40-100 μm | 60 | 55 | 50 | 70 | 60 | 90 | 94 |
| 100-300 μm | 18 | 19 | 16 | 5 | 13 | 27 | 29 |
| 300-800 μm | 3 | 5 | 7 | 2 | 7 | 10 | 17 |
| >800 μm | 0 | 0 | 0 | 0 | 0 | 1 | 2 |

1-8. (canceled)

9. A process for producing plastics moldings via thermoplastic processing of at least one polymer (a), of at least one plasticizer, and optionally of water, wherein polymer (a) comprises:
a.) from 15.0 to 99.9% by weight of structural units of the formula (1) 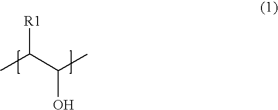
wherein R¹ is hydrogen or methyl;
b.) from 0.0 to 50.0% by weight of structural units of the formula (2): 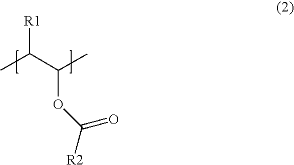
wherein R² is an alkyl radical having from 1 to 6 carbon atoms,
c.) from 0.0 to 50.0% by weight of structural units of the formula (3) 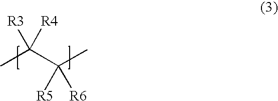
wherein each of R³, R⁴, R⁵ and R⁶, independently of the others, is a radical having a molar mass in the range from 1 to 500 g/mol,
based in each case on the total weight of the polymer (A), characterized in that the polymer (A) and the plasticizer are introduced with no prior mixing into the extruder, and that the proportion of water is less than 2% by weight, based on the polyvinyl alcohol.

10. The process of claim 9 wherein R³, R⁴, R⁵ and R⁶ are independently aliphatic or cycloaliphatic and which are optionally substituted with one or more carboxylic acid, carboxylic anhydride, carboxylic ester, carboxamide and/or sulfonic acid groups.

11. The process of claim 9, wherein Polymer A has a degree of hydrolysis in the range from 70 to 100 mol % and a viscosity, measured on a 4% by weight aqueous solution, in the range from 2 to 70 mPas.

12. The process of claim 9, wherein the plasticizer comprises polyhydric alcohols, derivatives of polyhydric alochols, polyethylene glycols, glycerol, diols, or triols, or mixtures thereof.

13. The process of claim 9, wherein the polymer(s) and the plasticizer(s) and, when present, the water is processed with a lubricant, an antiblocking agent, an anti-oxidant, a pigment, a dye, a solid plasticizer, and/or a filler.

14. The process of claim 9, wherein the thermoplastic processing takes place by means of melt extrusion.

15. The process of claim 9, wherein polymer (A) has been internally plasticized.

16. A polyvinyl alcohol molding prepared by the process of claim 9.

17. A polyvinyl alcohol molding prepared by the process of claim 10

18. A polyvinyl alcohol molding prepared by the process of claim 11.

19. A polyvinyl alcohol molding prepared by the process of claim 12.

20. A polyvinyl alcohol molding prepared by the process of claim 13.

21. A polyvinyl alcohol molding prepared by the process of claim 14.

22. A polyvinyl alcohol molding prepared by the process of claim 15.

23. A packing material comprising the molding of claim 16.

24. A packing material comprising the molding of claim 17.

25. A packing material comprising the molding of claim 18.

26. A packing material comprising the molding of claim 19.

27. A packing material comprising the molding of claim 20.

28. A packing material comprising the molding of claim 21.

29. A packing material comprising the molding of claim 22.
